(19) United States
(12) Patent Application Publication
(10) Pub. No.: US 2012/0330449 A1
(43) Pub. Date: Dec. 27, 2012

(54) RAPID CONVERTING OF SHEET MATERIAL METHODS AND APPARATUS

(75) Inventors: GLENN EDWARDS, Palo Alto, CA (US); Lorne Bechtel, Los Altos, CA (US); Marie Bechtel, Los Altos, CA (US)

(73) Assignee: Rapid Converting LLC, Palo Alto, CA (US)

(21) Appl. No.: 13/467,432

(22) Filed: May 9, 2012

Related U.S. Application Data
(63) Continuation of application No. PCT/US2010/056083, filed on Nov. 9, 2010.
(60) Provisional application No. 61/259,463, filed on Nov. 9, 2009.

(51) Int. Cl. B26D 7/26; G06F 19/00

(52) U.S. Cl. 700/97; 83/640; 83/582

(57) ABSTRACT

Methods and apparatus provide an input for a user located remote from a cutting machine to cut a part. The user can instruct the cutting machine to cut the part to the user's specification in many ways, for example such that the user can instruct the cutting machine without having knowledge of the machine's cutting processes or construction. The methods and apparatus of the embodiments described herein can convert a machine processes into an image of the part to be cut such that the user can easily view and understand the image of the part to be cut remote from the cutting machine.

### CROSS-REFERENCES TO RELATED APPLICATIONS

The present Continuation application claims priority to PCT Application No. PCT/US2010/056083, filed 9 Nov. 2010, entitled “Rapid Converting of Sheet Material Methods and Apparatus”, which application claims priority to U.S. Provisional Patent Application Ser. No. 61/259,463, filed 9 Nov. 2009, entitled “Rapid Converting of Sheet Material Methods and Apparatus”, the full disclosures of which are incorporated herein by reference.

### BACKGROUND OF THE INVENTION

The present invention is related to the conversion of sheet material to finished goods such as machined parts, gaskets, shims and sheet metal. Although specific reference is made to the converting of sheet material to gaskets, embodiments as described herein will have application to many industries where sheet material is converted to a part, for example rapid prototyping.

The prior methods of making parts such as gaskets and prototypes with computerized numerical control (hereinafter “CNC”) can be more expensive and time consuming than would be desirable in at least some instances. For example, gaskets can be manufactured from a machined metal press. Such metal presses can rely on a press that has a pre-formed shape that corresponds to the part manufactured. In at least some instances making a metal press that corresponds to a gasket can be time consuming and more expensive than would be ideal. Also, at least some of the known methods of manufacturing metal presses can waste at least some of the material used to make the press and require more energy than would be ideal in at least some instances. At least some prior manufacturing processes use a cutting tool, with a blade shaped to cut the entire gasket with one punching cycle, and strike the shaped cutting tool against a cutting table, and in at least some instances there can be clearance above the cutting table such that the cutting of the part is incomplete, sometimes referred to as a kiss-cut, or there can be interference of the shaped blade cutting into the cutting table which can result in wear of the cutting blade, the table and associated machinery in at least some instances.

Although lasers can be used to cut material, the prior methods of cutting with lasers can be less than ideal in at least some instances. At least some of the current methods of cutting lasers may cause a zone of thermal damage in at least some instances when the material is cut. Also, in at least some instances lasers can produce toxic gases and vapor material in at least some instances, and such laser systems may use a debris removal system that can be more complex than would be ideal. For example, at least some plastics such as poly vinyl chloride (hereinafter “PVC”) can release a toxic gases when cut in at least some instances. Although the debris removal systems may trap the toxic material, the debris removal system comprises the trapped toxic waste and require special toxic waste handling in at least some instances.

Although water jets can be used to cut material, in at least some instances water jets may use an abrasive material that can contaminate the cut material in at least some instances. For example, foam can be contaminated with an abrasive of the water jet in at least some instances, and wetting of the material can make handling more difficult and result in contamination in at least some instances.

Although three dimensional rapid prototyping, for example with overlapping laser beams, can be used to manufacture at least some prototype parts with stereo-lithography, such systems can be more expensive and complex than would be ideal. For example, the accuracy of such systems can depend at least in part of the alignment of the optical system and corresponding laser beams. Also, the use of photo-reactive materials can limit to at least some extent the materials that can be formed with the stereo-lithography systems, and at least some of the prior resins can be toxic in at least some instances.

Work in relation to embodiments of the present invention suggests that prior methods and apparatus for handling sheet material can be less than ideal, for example elastomer material that can stretch. For example, lateral stresses of the material may result in distortion of the pattern when cut in at least some instances.

In light of the above, it would be desirable to provide improved methods and apparatus that would overcome at least some of the above mentioned short-comings of the prior methods and apparatus. Ideally, such methods and apparatus would provide improved conversion of a wide variety of materials to parts of many sizes and shapes, so as to overcome at least some of the limitations of the prior methods and apparatus.

### BRIEF SUMMARY OF THE INVENTION

Embodiments of the present invention provide improved conversion of sheet material to finished goods such as machined parts, gaskets, shims and sheet metal. Although specific reference is made to the machining of sheet material to gaskets, embodiments as described herein will have application to many industries where sheet material is converted to a part, for example rapid prototyping.

The methods and apparatus of the embodiments described herein can provide a means for a user such as a customer located remote from a cutting machine to cut a part. The user can instruct the cutting machine apparatus to cut the part to the user's specification in many ways, for example such that the user can instruct the cutting machine apparatus without having knowledge of the machine's cutting processes or construction. The methods and apparatus of the embodiments described herein can convert cutting machine processes into an image of the part to be cut such that the user can easily understand and view the image of the part to be cut remote from the cutting machine apparatus. The means for a customer user to cut a part may comprise components of a processor system, such as a processor, a computer readable medium and a display remote from the cutting machine apparatus. The image of the part to be cut can be shown on the display of the customer user. The customer user can be at a first location such as at home or at an office and the cutting machine can be located at a second location remote from the user, for example in another building or in another town when the image is viewed. The user processor coupled to the user display may comprise instructions of a computer program stored on a computer readable medium such as a computer memory, and the computer program may comprise instructions to display the image of the part to be cut to the user. The image displayed to the customer user may comprise an image transmitted from a location remote from the customer user.

In many embodiments, the apparatus comprises a head and cutting tool coupled to a computer system to cut a part having a profile from a sheet of material positioned on a support. The cutting tool may comprise a blade to cut the material when positioned on the head, and an angle of the blade can be adjusted under computer control so as to cut the sheet material in accordance with the profile of the part. The blade may comprise an elongate blade such that the part can be cut rapidly, and the blade aligned in accordance with the cut profile of the part. The cutting tool may comprise a first component to cut the sheet material with force to the blade and a second component to maintain the angle of the cutting angle of the blade, such that the cutting angle can be controlled accurately. The cutting tool may comprise a first curved surface coupled to a second curved surface so as to adjust an angle of the blade relative to the upper surface of the sheet and such that the sheet is cut uniformly. A processor system can be coupled to the cutting tool, and the processor system may comprise a factory processor server remote from the user. The user located remote from the cutting tool can upload a drawing and input selections to the server. The server can download a file comprising cut profiles and material information in response to the uploaded file and conditions of the factory floor such as the tooling available. For example, the user can view an initial image comprising a first initial profile of the part of the drawing overlaid on a second cut profile corresponding to the cut part, such that the user can confirm the part cut with the cutting tools and process is suitable. A bed can be coupled to the cutting machine to secure the sheet material such that the sheet material does not shift positions during the cutting of the sheet material. This bed can include a vacuum system to hold down the material and may comprise of sintered material so as to distribute the vacuum around an outer portion of the material, and the outer portion may encompass a perimeter of the material. A press plate can be used to hold the sheet material on the bed in a substantially unstrained manner, so as to decrease distortion of the material when cut, for example so as to decrease distortion of cut elastomer material, and the press plate can be used with a sheet material set-up process to position and hold the material on the bed so as to decrease distortion of the cut part.

### BRIEF DESCRIPTION OF THE DRAWINGS

FIG. 1A shows an apparatus to convert sheet material to at least one fabricated part in accordance with embodiments;

FIG. 1B shows a head and cutting tool of the apparatus as in FIG. 1A;

FIGS. 2A-2D show the cutting tool of the apparatus, in accordance with embodiments;

FIG. 2A1 shows a cutting tool comprising a substantially circular blade, in accordance with embodiments;

FIGS. 2E1, 2E2, 2E3 and 2E4 show isometric, side, side cross-sectional and end cross-sectional views of the shaft of the cutting tool apparatus as in FIGS. 2A-2D;

FIG. 3A to 3D show a cutting table of the apparatus, in accordance with embodiments;

FIG. 4 shows a sheet cut with incisions so as to define a part comprising a gasket, and tabs of uncut material extending between the incisions;

FIG. 5A shows a processor system, in accordance with embodiments;

FIG. 5B shows the factory server of the processor system of FIG. 5A;

FIG. 5C shows the cutting machine supervisory process of the processor system of FIG. 5A;

FIG. 5D1 shows a user interface screen to receive input of a first user step, in accordance with embodiments;

FIG. 5D2 shows a user interface screen to receive input of a second user step, in accordance with embodiments;

FIG. 5D2A shows the Maximum Material Condition for External and Internal Edges;

FIG. 5D2B shows Minimum Material Condition for External and Internal Edges;

FIG. 5D2C shows the Best-Fit Condition for External and Internal Edges;

FIG. 5D3 shows a user interface screen to receive input of a third user step, in accordance with embodiments;

FIG. 5E shows a user input gasket image of the user interface screen, in accordance with embodiments;

FIG. 5F shows a target cut gasket image of the user interface screen, in accordance with embodiments; and

FIG. 5G shows the user input gasket image overlaid on the target cut gasket image, in accordance with embodiments.

### DETAILED DESCRIPTION OF THE INVENTION

Embodiments of the present invention can be used in many ways to improve the manufacturing of sheet materials and to provide manufactured materials in an efficient manner with a processor system The ordering and manufacturing processes allows a user to order a part remotely from the cutting tool apparatus and view an image of the part to be received with the image of the part sent. The order and manufacture process can be implemented with a processor system that may comprise a user computer processor, a factory server processor, and a apparatus and processor to cut the material. The user and the user processor can be located remotely from the cutting tool apparatus, and instructions of the processor system can be codified in software running on the processors. The cutting tool coupled to the processor system can convert sheet material to finished goods with instructions of the processor system based on input of the remote user. For example, elastomer sheet goods can be manufactured into finished products such as gaskets and seals, although many goods can be manufactured such as shims and sheet metal.

The embodiments may comprise processes for remote users to manufacture, order and purchase parts such as gaskets on-line. The process can be implemented with instructions of the processor system and can be interactive such that the remote user can change parameters, related to the gasket and request for manufacturing comprising the purchase order, so as to effect manufacturing of the part, shipment of the part, price of the part and delivery of the part in accordance with the user instructions of the order and the availability of cutting tools and sheet material in the factory. User selectable parameters include fabrication tolerance, material condition, gasket material and a quantity of the parts, for example an order quantity. An on-line, interactive ordering process allows the user to specify material condition (Maximum, Minimum and Best-fit), and manufacturing tolerance (specified in units of length), such that the user can ensure the part is manufactured according to his or her own preferences. The processor system can implement a automated process wherein a price is determined by the factory server processor and fed back to the customer in substantially real time, such that the remote user can make the decision to order. The user can upload a file to the factor server processor. The factory server processor can use software instructions of a computer program so as to process the remote user's gasket design. For example the user computer can upload a drawing file such as a DXF file, which comprises a digital vector-based drawing file. The factory server processor can generate a cut profile of the part based on an approximation of the gasket design profile, and the cut profile can be written to a cut-file. The cut profile of the part is based on parameter inputs from the user and cutting tools loaded on the cutting apparatus, material properties and the availability at the time of order.

The cut file comprising the profile can be sent to the user processor to display an image of the cut profile on the remote user processor. The user is shown the image of the cut-file and the original gasket design profile. The user can approve the cut profile shown in the image from the cut file. Based on the approval by the user, the cutting tool can cut the part using a relatively small set of cutting tools, and can cut gaskets of many shapes and many sizes.

The manufacturing process can be automated and internet based with the cutting tool and processor system. The configuration of the system can be based upon sending and receiving data files such as XML files. The data files such as XML files can be uniquely configured to carry and exchange information and instructions among the computers of the processor system and whose contents can be readily displayed to the remote user using generic, web browsers. The data files can be transmitted among the processors of the processor system and stored on tangible media of the processor system. Through the use of these files, the manufacturing process may be monitored by factory personnel in remote situations, for example via the internet, or on the floor via an intranet. The processor system and communication among the processors can automate the process and link one, or many cutting machines, to a central factory server so as to allow the cutting machines to be grouped and managed based on a variety of properties such as material, tooling and physical location. The configuration of the system can also be based upon a data-base system where the data is not stored in individual files but as one large data base file.

The processor system and factory model can be distributed in many ways across geographic territory so as to delivery the manufactured part to the user remote from the cutting tool. Due to the energy expenditure of shipping and cost structure of shipping the cut product to the user, dividing the geographic territory can be divided into regions based upon trucking routes and airline hubs, so as to decrease the distance the cut part is shipped.

The cutting apparatus and process may use a predetermined force to cut the material. The cutting tool and process can be based on the application of force to the sheet material, for example without reliance on a specific distance of the edge cutting blade into the material. The cutting tool and apparatus can use a cutting that is generating with the force through the use of mechanical springs. For example, the force of compressed spring can be determined based on the spring rate, also referred to as spring constant, multiplied by distance of compression of the spring. The force could also be created with, for instance, air or hydraulic cylinders coupled to the cutting blade. The cutting tools may not rely on rigid coupling of the cutting blade to the CNC positioning actuators, such that the cutting of the part may not rely on an exact cutting distance. As the cutting is based on force, the exact cutting distance and position of the lower edge of the blade on the table may not be a process parameter. Therefore the machinery may not rely on tight tolerances in the vertical cutting direction, such that the machines and cutting tools can be less complex and more efficient.

The cutting tool and apparatus are designed to generate a variable cutting force that is predetermined with instructions of the processor system, for example the processor of the apparatus so as to implement the cutting algorithm for the cutting apparatus. The instructions of the computer program embodied on the computer readable media of the processor system can implement an algorithm that takes as input parameters the material type, the material properties, the material thickness, the length of the cutting blade and the blade wear so as to determine the cutting force to be applied. Each cutting tool can be capable of generating a wide range of cutting forces, as determined and controlled by the cutting algorithm. For example, the force of the blade for an amount of compression can be determined, and the blade can be slidably coupled to a housing, such that the housing can be moved downward to compress the spring and generate force when the blade contact the material, and the vertical displacement of the housing downward to compress the spring can be determined based on the material and thickness so as to generate the predetermined cutting force. The cutting tool and instructions of the processor system can be used with a variety of materials and material conditions. As the material shape can be determined with a plurality of cuts, for example a plurality of substantially straight cuts from one or more blades, the blades can be re-used to make many parts comprising substantially different profiles.

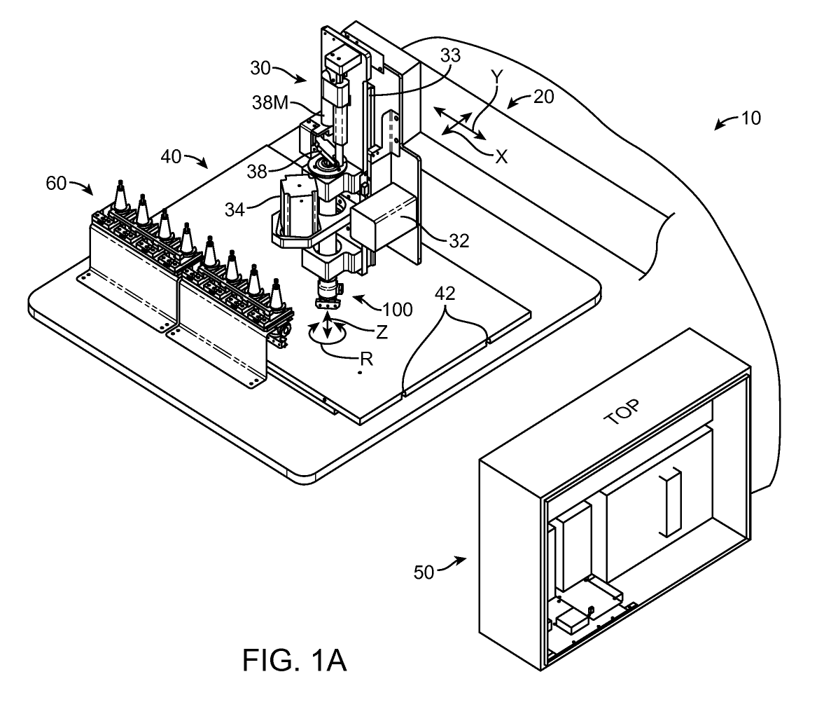

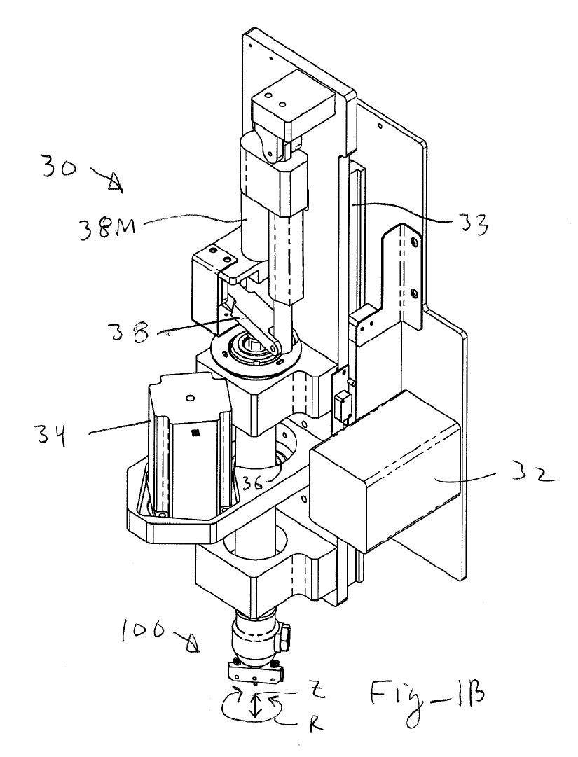

FIG. 1A shows an apparatus 10 to convert sheet material to at least one machined part. The apparatus 10 comprises a cutting tool 100 to cut the sheet material with force. The apparatus 10 may comprise components of a four axis CNC router. The apparatus 10 comprising a linkage to move the cutting tool with translational movement in three dimensions and a fourth rotational axis to adjust an angle of the blade. The linkage may comprise x-y translational components 20, and the x-y translational components may comprise components of a commercially available gantry router modified in accordance with the embodiments described herein. A head 30 may be coupled to the x-y translational components 20, and head may comprise additional components of the linkage to move the cutting tool 100. The head 30 may comprise components to move cutting tool 100 vertically along a Z axis and rotational components to rotate the cutting tool about the z-axis. The head 30 may comprise a motor 32 coupled to a rail 33 to move the cutting tool 100 along the z-axis. The head 30 may comprise a motor 34 to rotate the head with rotation R about the z-axis. The motors may comprise many known motors such as one or more of servo motors or stepper motors.

The apparatus 10 comprises circuitry 50 to drive the cutting tool 100 with computerized numerical control. The CNC circuitry can be coupled to cutting tool so as to cut the part with coordinate references along the x-y dimensions of the sheet material and with the rotation R about the Z-axis. The force of the cutting blade to the material can be controlled and configured based on the material cut. For example, the cutting tool may comprise a spring, and the cutting tool can be driven downward to a location along the Z-axis such that the blade cuts the material with for in response to compression of the spring. The circuitry 50 may comprise a processor and drive electronics coupled to the motors of the head and x-y translational components. For example, G-code can be loaded on the processor of the circuitry 50 and used to control positions of the components based on commands of the processor. The circuitry 50 may comprise amplifies and electronics to drive the motors in response to the commands from the processor.

The apparatus 10 may comprise a magazine 60. The magazine comprise a plurality of cutting tools similar to cutting tool 100. The plurality of cutting tools may comprise cutting tools having blades of suitable length and diameter to cut material as specified by the user and/or customer. The plurality of cutting tools may comprise blades of many shapes, for example one or more of straight, circular, arcuate or elliptical. The apparatus 10 can be configured to automatically position cutting tool 100 in the magazine 60 and select another cutting tool from the magazine, for example in accordance with instructions of the processor system. A motor 38M can be coupled to a lever arm 38 to connect one of the plurality of cutting tools to the head 30 disposed in the magazine 60, so as to select and remove the cutting tool for use. The motor 38M can move the lever arm 38 to release the release the cutting tool into the magazine when the cutting job is completed.

The apparatus 10 comprises a bed 40 to hold the sheet material in position for cutting with tool 100. The bed 40 may comprise a vacuum manifold to hold the sheet material and ports 42 to connect to a vacuum source.

FIG. 1B shows a head and cutting tool of the apparatus as in FIG. 1A. The head 30 may comprise a gear 36 to rotate the cutting tool 100 rotation R about the Z-axis 100. Motor 34 can be coupled to gear 36 to rotate the cutting tool. A lever arm 38 can be coupled to the cutting tool 100 so as to connect the cutting tool 100 to the head when the lever arm 38 is configured in a first position and release the cutting tool 100 when the lever arm 100 is configured in a second position.

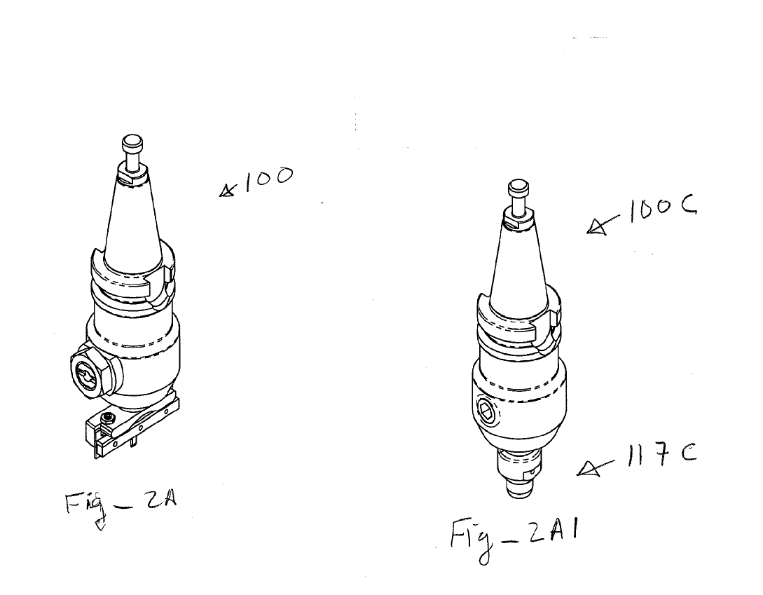

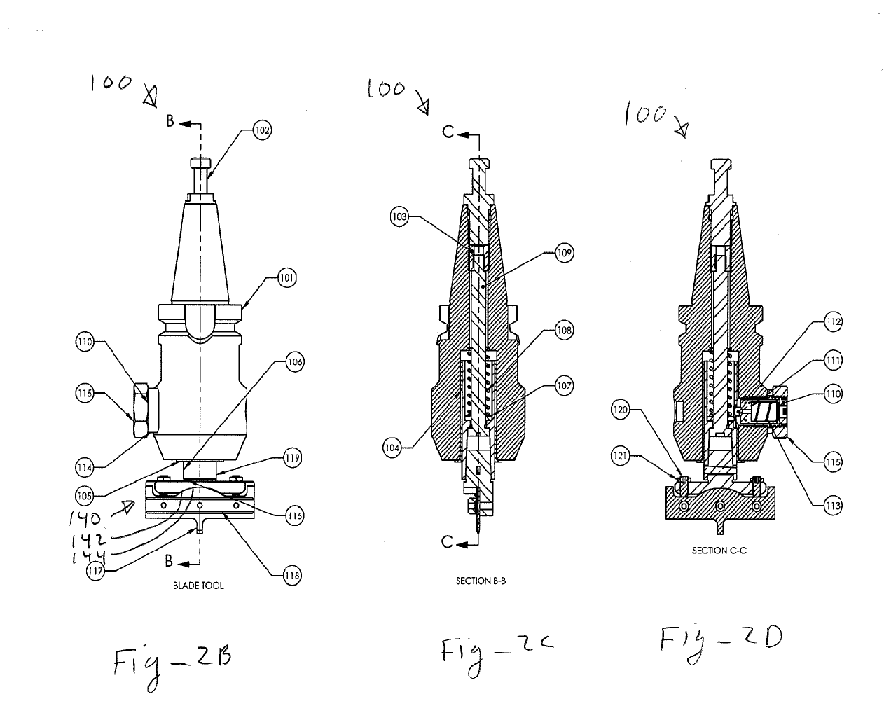

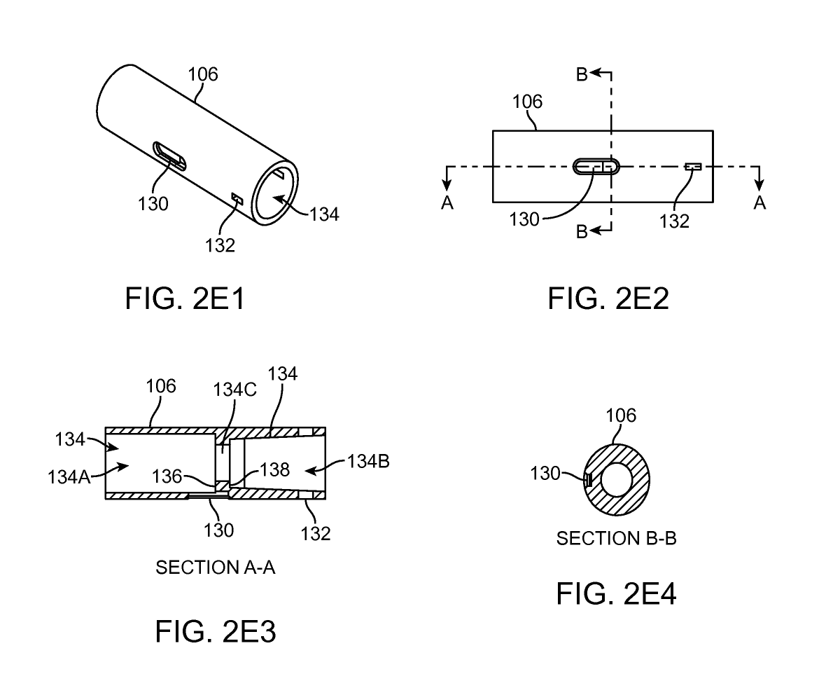

FIGS. 2A-2D show the cutting tool 100 of the apparatus 10. FIG. 2A shows an isometric view of cutting tool 100 configured for placement in the head 30. FIGS. 2B to 2D show a side profile, a first cross-sectional view, and a second side cross-sectional view, respectively, of the cutting tool 100. The cutting tool 100 comprises a blade 117 to cut the material, and a housing 101 to house many of the components of cutting tool 100. The cutting tool 100 comprises a housing 101 that can be used to position cutting tool 100 in head 30. A pull stud 102 is located on an upper end 102 of cutting tool 100, such that cutting tool 100 can be drawn toward head 30 and held in place with the conic section that engages a similar conic section of head 30. A threaded bushing 103 is located within a channel of the housing below the pull stud 102, so as to position the mandrel 109 within the vertical channel of cutting tool 100.

A shaft 106 comprises a shaft 106 affixed to cutting blade 117. The shaft 106 of cutting tool 100 extends along the vertical channel between the blade 117 and mandrel 109. The cutting tool 100 comprises a washer 107 coupled to and a compression spring 108. When the housing is positioned downward such that the blade contacts the sheet material, the shaft 106 slides along the channel so as to compress the spring and urge the cutting blade into the material. A bushing 104 comprising a sleeve is disposed within the channel of the housing of the cutting tool 100, and the bushing sleeved guides shaft 106. A flange 105 of bushing 104 is located on a lower side of the cutting tool to hold the bushing 104 in position along the vertical channel.

As the vertical position of the head and housing 101 can be accurately positioned with computerized numerical control the force to cut the material with the blade can be accurately controlled by positioning the housing to a desired location, such that the sheet material can be cut with accurately adjusted force based on the vertical position of the housing and the compression of the spring.

The cutting tool 100 comprises a mechanism to maintain an angle of rotation R of the cutting blade 117 so as to inhibit one or more of backlash or hysteresis of the blade 117. Work in relation to embodiments suggests that errors in rotational movement R can result in a cut part with jagged edges in at least some instances, and the cutting tool 100 can comprise pre-loading with of components, such that the blade rotational movement R to an angle of the cut profile is accurate. The pre-loading to inhibit the backlash or hysteresis may comprise a resilient member such as a spring or force from a pressure such as pneumatic or hydraulic pressure. The cutting tool can comprise a first component urge the blade in a first downward direction to cut the tool, for example the shaft, and the mechanism to inhibit backlash and hysteresis of the rotational movement R can comprise a second component. The second component to inhibit backlash can be coupled to the first component in a second direction different from the first direction, for example transverse to the first direction. The anti-backlash mechanism may comprise a detent, and the detent can preload the cutting tool with a force in the second direction transverse to the first direction when the shaft slides and the blade moves to cut the sheet. The detent may comprise an screw 110, a piston 111, a bearing 112 and a compression spring 113. A washer saddle 114 may comprise threads to receive a nut 115. Advancement of nut 115 can compress spring 113 so as to urge bearing 112 against the shaft 106 maintain angle of rotation R in response to movement of motor 34 coupled to gear 36. Nut 115 can be advanced such that alignment of the shaft is maintained without substantially drag.

FIG. 2A1 shows a cutting tool 100C comprising a substantially circular blade 117C. The magazine 60 may comprise a plurality of circular cutting tools, in which each circular cutting tool of the magazine comprises a blade of different diameter.

FIGS. 2E1, 2E2, 2E3 and 2E4 show isometric, side, side cross-sectional and end cross-sectional views of the shaft 106 of the cutting tool apparatus as in FIGS. 2A-2D. Shaft 106 comprises a channel 130 to receive the bearing 112. Bearing 112 can slide along channel 130 to maintain alignment of the cutting blade. The shaft 106 comprises channel 130, for example a slot. The shaft 106 comprises a first substantially annular portion 134A to slide along the mandrel and compress the spring, and a second substantially annular portion 134B with an inner taper. An intermediate portion of the channel 134C can extend between the first inner channel portion 134A and the second channel portion 134B. The intermediate portion 134C may comprise a diameter smaller than the first channel portion and the second channel portion so as to define a first shoulder 136 and a second shoulder 138. The second shoulder 138 can engage a rim on the distal end of the mandrel so as to from a stop. The first shoulder 136 can support a washer so as to compress the spring when the blade touches the sheet material.

Referring again to FIGS. 2A-2D, the cutting tool 100 comprises a blade holder, such that blade 117 can be removed from the cutting tool, for example for sharpening.

Cutting tool 100 comprises a plate holder 118 and a key 119 of the cutting tool. The key 119 can fit the hole 132 in the shaft to hold the blade support on the housing.

The cutting tool 100 comprises a mechanism and structures so as to adjust the angle of the blade to the cutting surface of the bed such that the material can be cut uniformly with blade 117. The mechanism may comprise an upper support coupled to the housing with a lock and key. The lower support may be rigidly connected to the blade. The structures of the mechanism may comprise a joint 140 formed with the lower support having a convex surface 144 and the upper support with a concave surface 144. The upper support may comprise a first plate machined from a piece of material and the lower support may comprise a second plate formed from a second material, and the plates can be tiled with the curved surfaces so as to adjust an angle of the inclination of the blade to the surface of the cut sheet. The curved surfaces may comprise cylindrical curved surfaces, but can be spherical. The curved upper and lower surfaces comprise a radius of curvature that corresponds to the blade so as to pivot the blade. The radius of curvature of the curved surfaces can extend from the curved surfaces to the blade, for example such that an axis of the cylinder passes through the blade. The blade can pivot about the axis of the cylinder, without changing substantially the separation distance of the center of the blade to the shaft so as to facilitate alignment of the blade.

The support to support the blade and connect the blade to the housing may comprise an adjustable threaded structure such as a set screw 120 and a nut 121 coupled to threads of the set screw so as to adjust a pivot angle of the blade with set screw and the nut. A similar set screw and nut can be disposed opposite the set screw 120 and nut 121. A first separation distance of the upper support and the lower support can extend along the set screw 120 on the first side of the support, and a second separation distance of the upper support and the lower support can extend along the similar set screw on the second side of the support. The first separation distance can be adjusted opposite the second separation distance such that the lower edge of the blade is substantially aligned with an upper surface of the sheet.

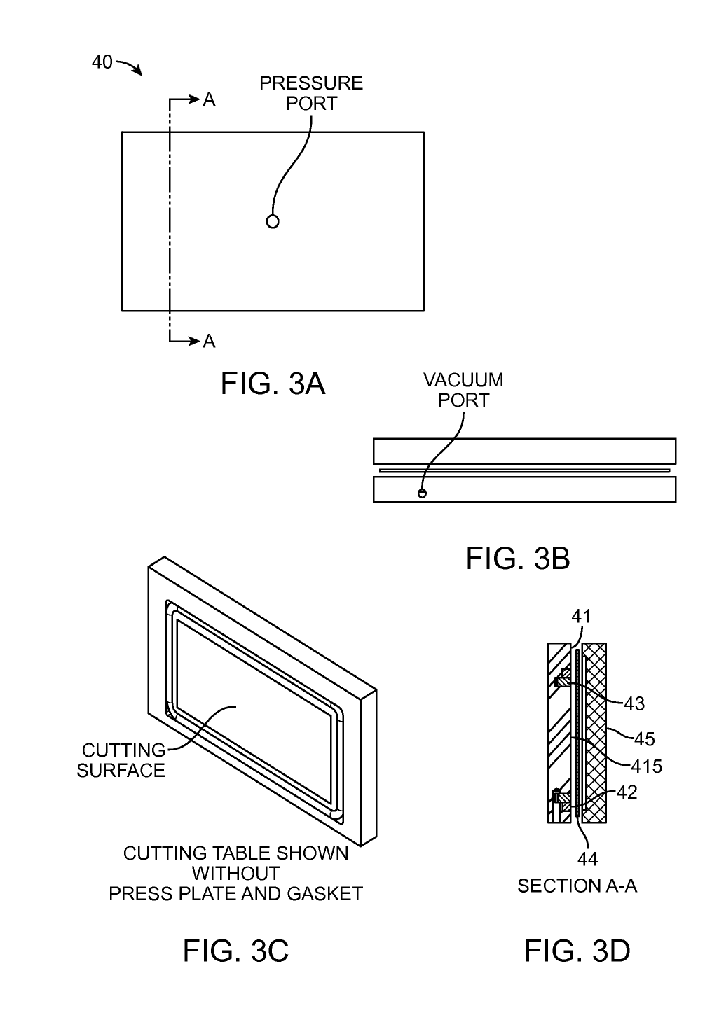

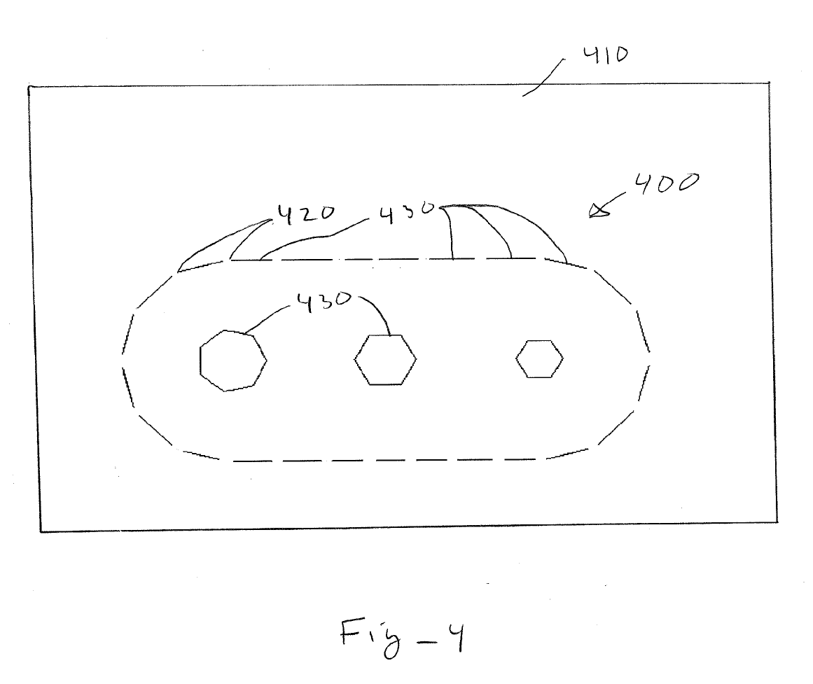

FIG. 3A to 3D show a top view, a side view, an isometric view and a side cross-sectional view, respectively, of cutting table 40 of the apparatus 10. The cutting table 40 comprises a cutting board 41, and the cutting board 41 may comprise many synthetic and natural materials. The cutting board 41 comprises cutting surface 41S. The cutting table 40 comprises at least an inner channel and an outer channel. The cutting board 41 may comprise a tube seal 42 disposed along an outer portion of the outer channel to seal the sheet material against the table. The cutting board 41 may comprise a manifold comprising sintered material 43 disposed along an inner portion of the outer channel and bounded with the tube seal, so as to distribute air flow and vacuum along the sheet material in contact with the sintered material The sheet of material 44, for example a sheet of gasket material such as an elastomer is shown positioned between a press plate 45 and the surface 41S of the cutting board 41. The cutting board 41 may comprise at least one pressure port to pass air through the surface 41S and float the sheet material.

The cutting board can be coupled to a source of pressurized air and a vacuum source to position the sheet material on the table and hold the sheet material on the table, for example without substantial lateral stress in the material.

The table can be used in accordance with the cutting tool as described herein and a process wherein an elastomer gasket material is affixed to a cutting table in a manner that imparts no substantial lateral stresses in the material. Work in relation to embodiments suggests that lateral stress can be associated with lateral strains in the sheet material that can induce errors in the parts when cut. The lateral strains encompass deformations that may result in a misshapen gasket when cut. This affixing of the sheet of gasket material can be achieved with the use of air pressure to deliver a substantially constant and substantially even force against the gasket prior to affixing it with a vacuum system. The process may comprise the following steps:

Floating the gasket material on a cushion of air, delivered through the vacuum port;
Bringing a Press Plate down upon Cutting Table and sealing the gasket between the Press Plate and Cutting Table;
Turning off air supply;
Turning on air supply delivered to Pressure Port of Press Plate;
Turning on vacuum to Vacuum Port of Cutting Table; and
Turn off air supply to Press Plate and remove Press Plate.

It should be appreciated that the specific steps illustrated above provide a particular method of affixing the sheet, according to embodiments of the present invention. Other sequences of steps may also be performed according to alternative embodiments. For example, alternative embodiments of the present invention may perform the steps outlined above in a different order. Moreover, the individual steps illustrated above may include multiple sub-steps that may be performed in various sequences as appropriate to the individual step. Furthermore, additional steps may be added or removed depending on the particular applications. One of ordinary skill in the art would recognize many variations, modifications, and alternatives.

FIG. 4 shows a sheet 410 cut with a plurality of cuts 430 so as to define a part 400 comprising a gasket, and tabs 420 of uncut material extending between the cuts. The part 400 may comprise inner holes. The part can be separated from the sheet with pulling so as to tear the sheet along the tabs that extend between the cuts. The sheet can be cut in many ways so as to define the part that can be separated with pulling and tearing along the performations. For example software can comprise instructions to cut the part with a separation between cuts so as to provide the uncut material between the cuts, or the blade may comprise a cut out portion, size or indentation so as to leave a portion of the material uncut. The part 400 may comprise a plurality cuts 430 so as to define inner holes. The sheet 410 can be sized for mailing, for example so as to fit within an envelope.

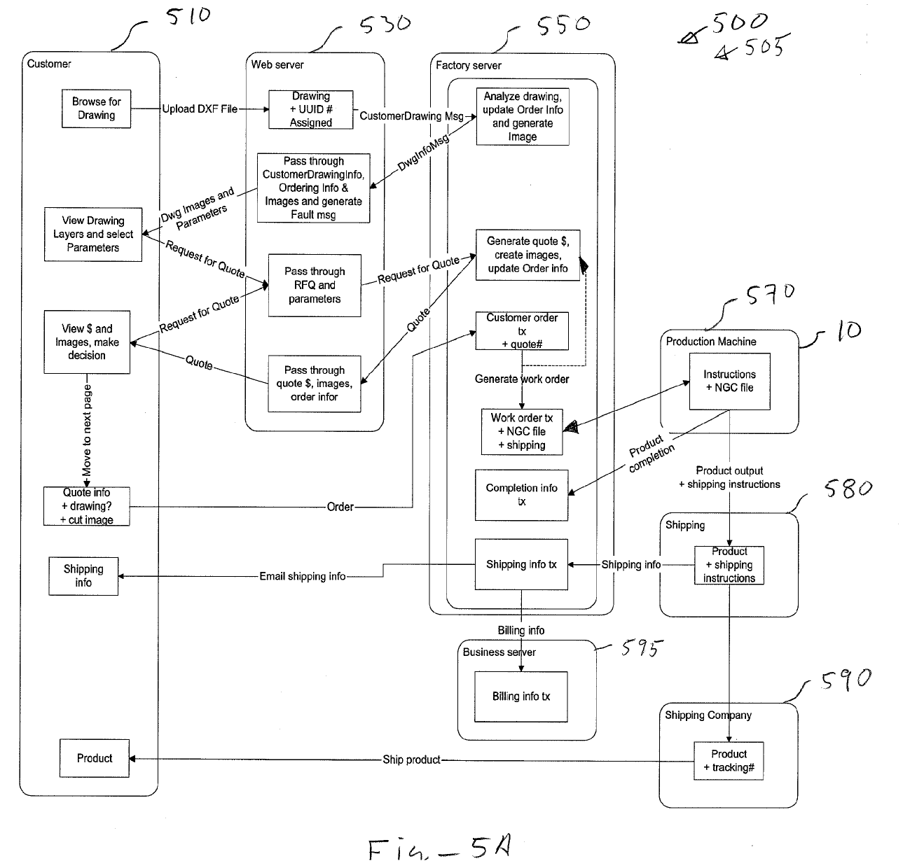

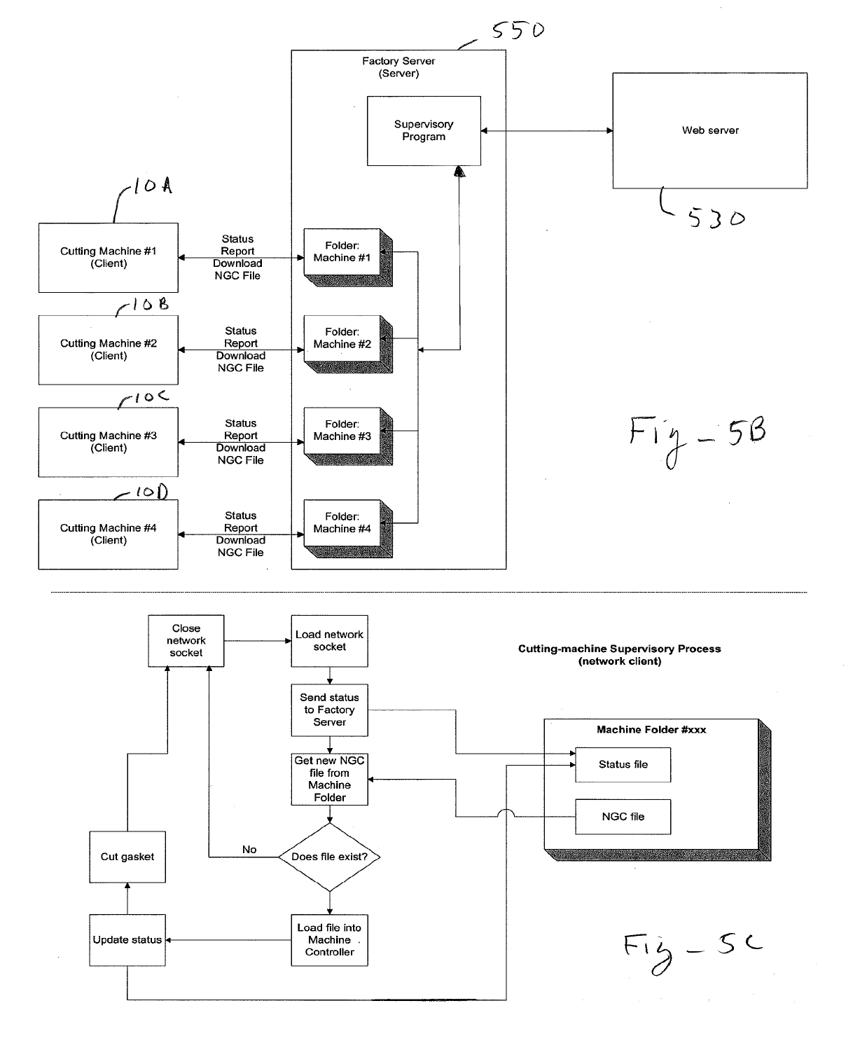

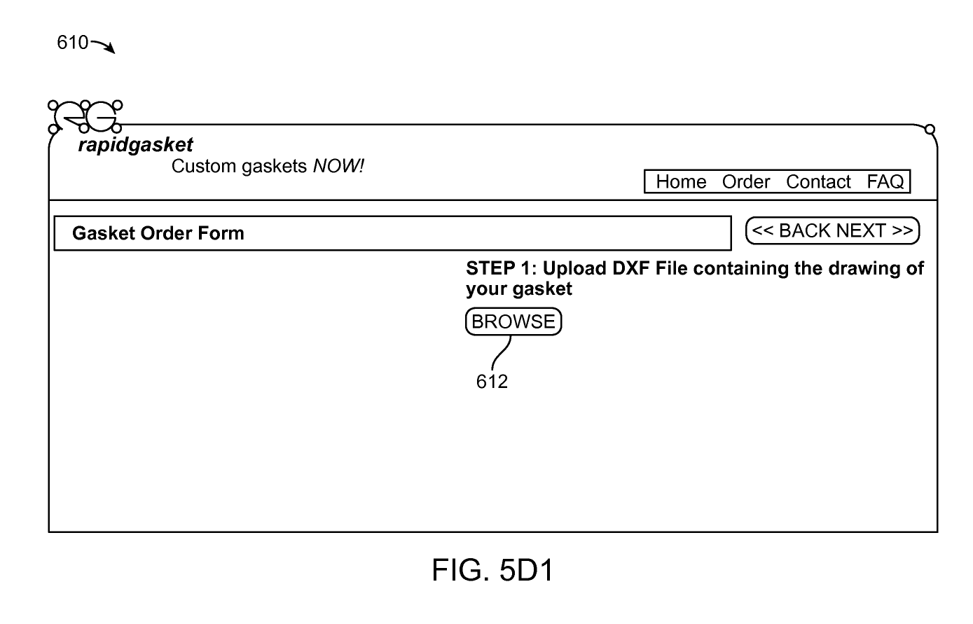

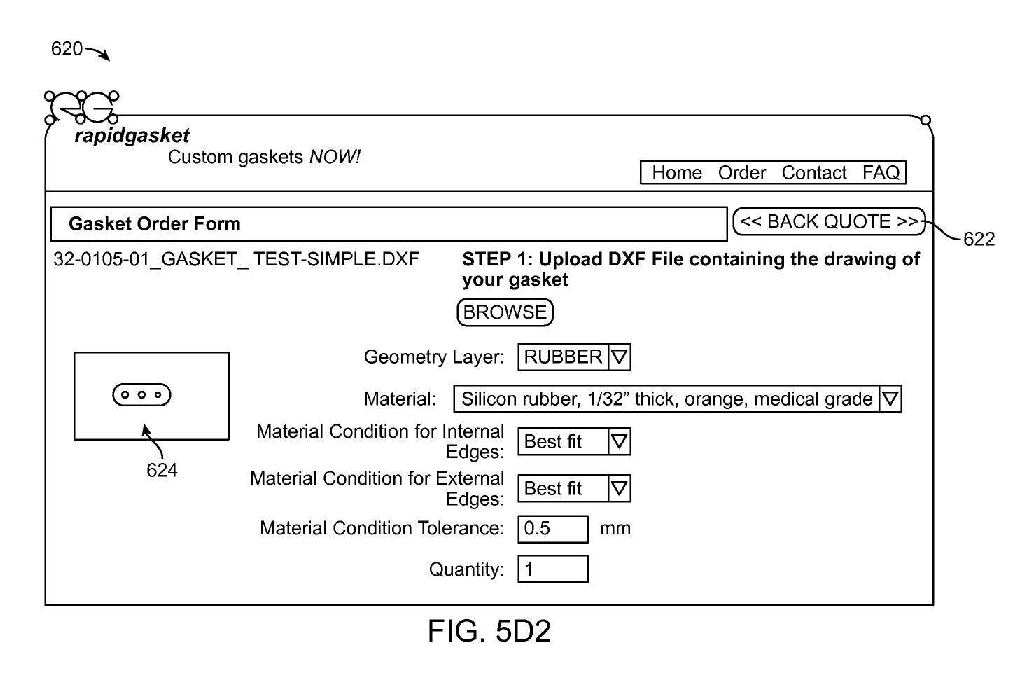

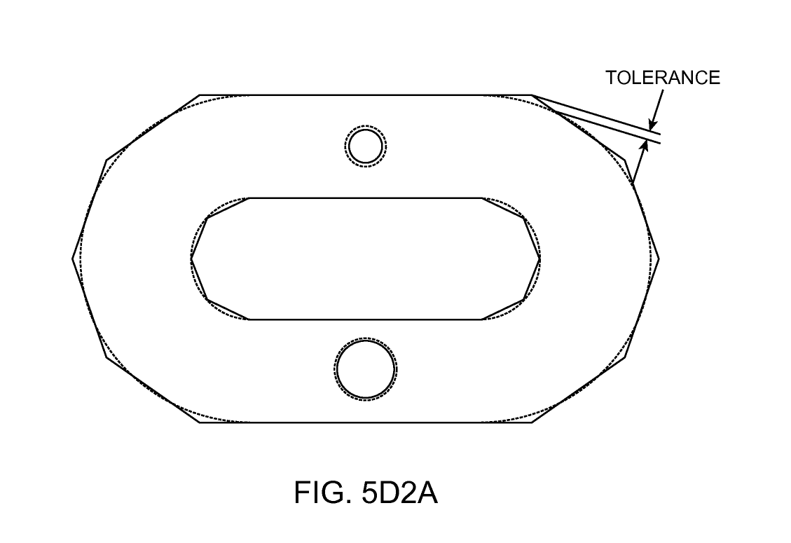

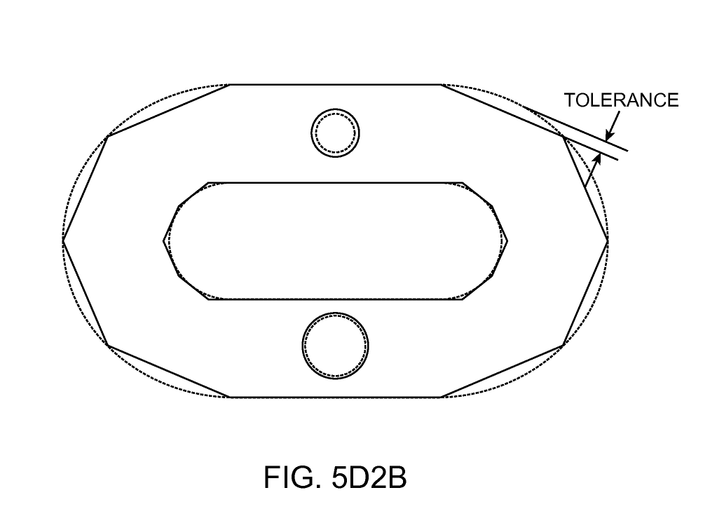

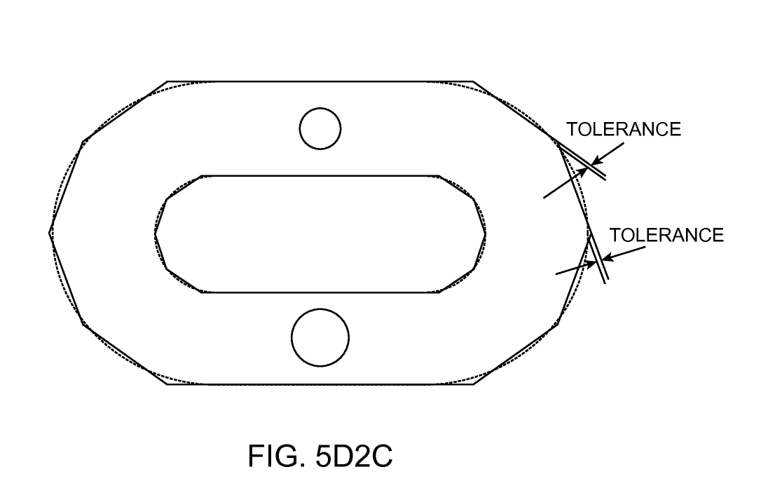

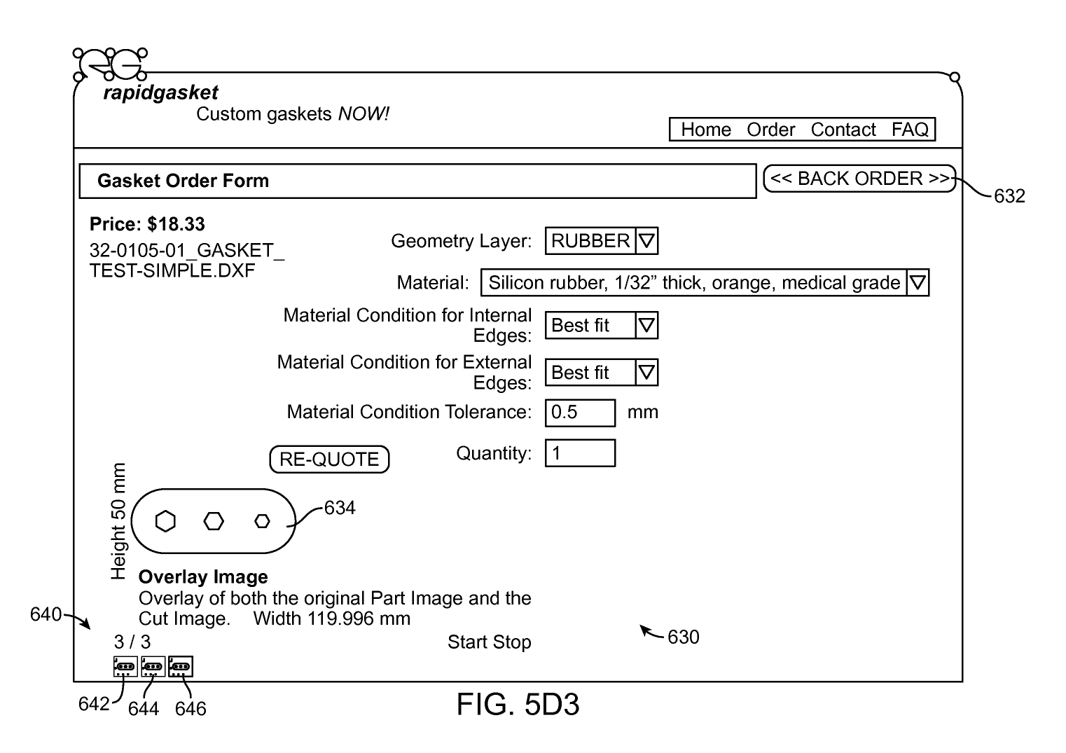

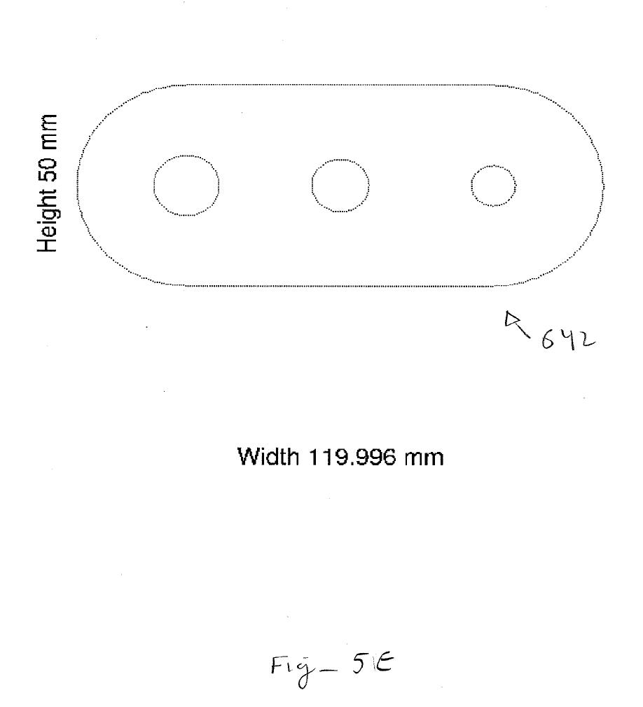

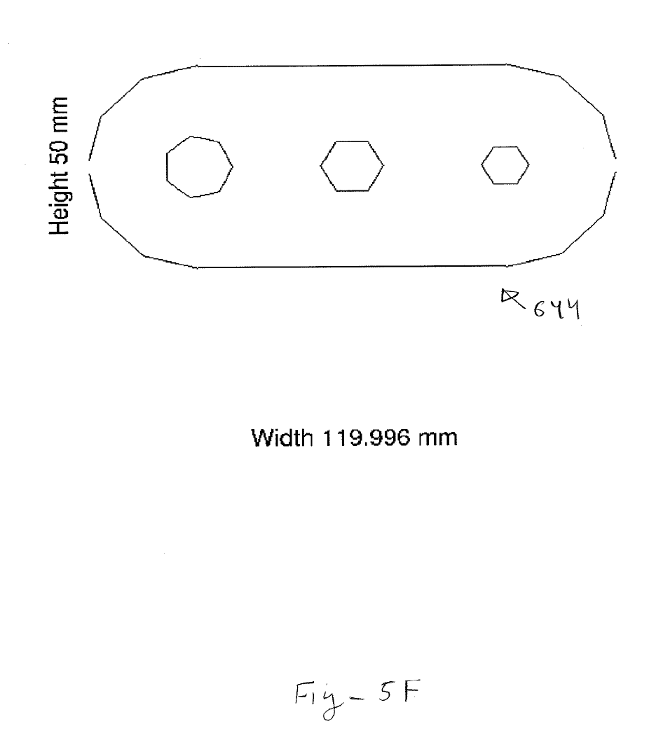

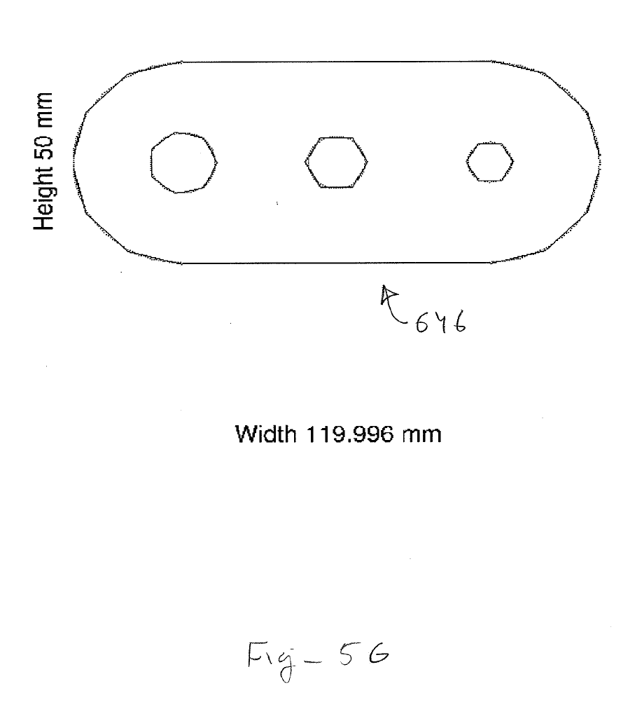

FIG. 5A shows a processor system 500. The processor system 500 comprises at least one processor comprising instructions configured to implement a method 505. The method may comprise steps implemented with instructions of the processor system. The processor system comprises a customer processor 510, a web server 530, a factory server 550, and a production machine 570 comprising a processor of the apparatus 10 as described above. The processor system 500 may comprise a shipping processor system to send instructions to a shipping company 590. The factory server 550 can be coupled to a transaction server 595 to send billing information. Each of the processor of the processor system may comprise instructions of a computer program embodied thereon. The processors of processor system 500 can be connected with communication protocols, such as known Internet and wireless communication protocols.

The customer processor 510 comprises a tangible medium having instructions of a computer program embodied thereon. The customer may comprise a user of the customer processor. The customer processor may comprise known components of a computer system, such as a personal computer comprising a tangible computer medium such as random access memory, and storage memory. The customer processor comprises a display to view images. The customer processor comprises instructions to upload a drawing file, for example a known dxf file such as a drawing file from a commercially available computer aided design program such as AutoCAD™. The drawing file may comprise components of the part, such as a profile of the part. The customer processor comprises instructions to view the drawing layers and select parameters, for example with the display screen. The customer processor may comprise instructions to view at least one image of the profile of the part and at least one image of the cut profile of the part, and instructions to select material and thickness of the sheet, and fit methods to fit the sheet to the cut profile. The customer processor can be configured to move to a next page, for example to a next a screen and to display quote for the price of the part or parts cut from the sheet material, and instructions to accept the part. The customer processor can be configured to receive shipping information. The customer processor may be configured to track arrival of the cut part at a facility of the customer. The customer processor may comprise a web browser, and the instructions of the customer processor may comprise instructions to the web browser.

The web server 530 comprises a tangible medium having instructions of a computer program embodied thereon. The web server may comprise hardware components of a known commercially available web server configured in accordance with the embodiments described herein. The web server may comprise a Universal Unique ID (hereinafter “UUID”). A commercially available programs or subroutine may generate UUID's, in a manner similar to random number generators, for example with a programmed to instructions of the processor system. The UUID can be used to name the files and to create identification numbers for tracking an order of a user, such as a customer. The order can be tracked with the UUID from a request of manufacture of the part to the shipment of the part, and the UUID can be used with interim steps such as instructions to the apparatus 10 to manufacture the part. The UUID's can be generated with two separate programs generating each of the UUID numbers separately. A first UUID program can be running on the web server, and second UUID can be running on the factory server, and the first and second programs can be configured so as to produce unique numbers, even though the separate programs are not linked. The UUID and drawing can be transmitted from the web server 530 to the factory server 550. The web server 530 can receive from the factory server and pass through customer drawing in ordering information and generate a fault message. The web server can receive a request for quote (hereinafter “RFQ”) from the user processor and pass through the request for quote and parameters selected by the user to the factory server. The web server can be configured with instructions to receive the quote, images and updated order info generated by the factory server and pass these through to the user computer.

The factory server 550 comprises a tangible medium having instructions of a computer program embodied thereon. The factory server 550 may be configured to receive the drawing, analyze the drawing, generate an image of the profile of the part and generate an image of the cut profile of the part so as to approximate the profile of the drawing the cut part profile comprising a plurality of lines, for example substantially straight lines and circles. The factory server can be configured to analyze components of the drawing file, such as layers or objects of the drawing file to determine layers of the drawing file and transmit the profile of layers of the drawing file to the user computer such that the user can select a layer for display on the layer computer. The factory server 550 can be configured with instructions to transmit the drawing information to the web server and to the customer server. The image of the cut profile and the image of the cut part can be generated on the factory server or the user processor, for example based on the cut file transmitted to the user processor. The factor server can be configured to generate a quote, create images and update part machining order information and transmit the information to the web server and the user processor. The factory server can be configured to receive an order from the user instructing manufacture of the part in accordance with the image on the user's computer. The factory server can generate an order to generate the work piece from the sheet material, in which the order comprises a work order. The work order can be configured for transmission to the production machine 570 comprising apparatus 10, for example to one of a plurality of the apparatuses. For example, the work order may comprise instructions of an NGC file, also referred to as G-Code, to cut the part from the sheet of material. The instructions may comprise many configurations of computer readable media and file formats so as to move the tool 100 in accordance with the image shown to the user. For example, the instructions may comprise a plurality of X-Y positions and a corresponding plurality of rotations R to form a plurality of cuts so as to cut the sheet. The file may comprise instructions for the cutting of the sheet of material, for example with a substantially constant vertical displacement among the cuts so as to cut the part with force. For example, the housing can be moved such that the blade is pressed against the upper surface of the plate when each cut is completed with an amount of force sufficient to cut through the lower surface of the sheet material and not damage the board or the blade.

The production machine 570 comprises a tangible medium having instructions of a computer program embodied thereon. The production machine receives the instructions from the factory server and cuts the sheet material as described herein and in accordance with the instructions and the NCG file. The production machine 570 may comprise instructions to transmit status to the factory server 550, for example status of materials on site, status of tools loaded and available, and completion of a transmitted cutting job and cutting jobs not yet completed. For example, the production machine 570 can transmit a product completion message to the factory server 550. The production machine 570 can output the product and shipping instructions to a shipping processor 580. The shipping processor can be located at a shipping dock and may comprise product and shipping instructions so as to ship the product to the user. The shipping processor can transmit shipping information to the factory server and the factory server can transmit the shipping information to the user indicating that the cut product has shipped, for example with email. The product and shipping instructions can be transmitted from a shipping location to a shipping company processor 590 The shipping company can ship the product to the user.

The business server 595 can receive billing information and transmit the billing information

FIG. 5B shows the factory server 550 of the processor system of FIG. 5A. The factory server 550 can be located with the cutting machine apparatus, or remote from the user and cutting machine apparatus. The factory server can be configured to control a plurality of apparatuses substantially similar to apparatus 10, for example a first apparatus 10A, a second apparatus 10B and a third apparatus 10C and a fourth apparatus 10D. The factory server 550 may comprise instructions of a supervisory program embodied thereon so as to supervise the cutting machines. The factory server may comprise a plurality of folders, for example one folder for each machine. The factory server can update the folder for each corresponding machine based on communication with the cutting machines. For example, the cutting machine can transmit a status report to the factory server for analysis and storage in the file, and the factory server can transmit the NCG file to the cutting machine. The cutting machines can be disposed at a plurality of locations so as to decrease time, cost and energy consumed with transit of the cut part from the cutting machine location to the user.

FIG. 5C shows the cutting machine supervisory process of the processor system of FIG. 5A and in accordance with a machine folder corresponding to a cutting machine. The supervisory process may comprise a network client. The supervisory process can be embodied on a computer readable medium of a processor located with the cutting machine apparatus, and may comprise instructions of the apparatus 10. For example, each cutting machine may run the cutting machine process separately and communicate with the corresponding folder of the factory server. The supervisory process may comprise the following steps:

a step to close a network socket;
a step to load the network socket;
a step to send status to the factory server;
a step to get a new NCG file from the machine folder;
a step to determine whether the new file exists; when the new file does not exist, the network is closed and when the new file does exist, the file is loaded into the machine controller;
a step to update the status can transmit status of the job, cutting material used and operational status of the machine to the machine folder; and
a step to cut the gasket.

It should be appreciated that the specific steps illustrated above provide a particular supervisory process, according to embodiments of the present invention. Other sequences of steps may also be performed according to alternative embodiments. For example, alternative embodiments of the present invention may perform the steps outlined above in a different order. Moreover, the individual steps illustrated above may include multiple sub-steps that may be performed in various sequences as appropriate to the individual step. Furthermore, additional steps may be added or removed depending on the particular applications. One of ordinary skill in the art would recognize many variations, modifications, and alternatives.

The user interface screen may comprise a plurality of configurations for the user to order manufacturing of the part.

FIG. 5D1 shows a first configuration of a user interface screen to receive input of a first user step. The user can select a plurality of conditions so as to define the manufacturing of the part, for example a layer condition, a material condition, an inner edge fit condition, an outer edge fit condition, a material quantity condition and a tolerance condition. The conditions for the part can be used by the factory server to determine instructions for the manufacture of the part transmitted to the apparatus.

The user interface screen is configured to the user to upload a drawing file, for example a dxf file. The user can press an input, for example clicking on a browse button 612 on the display to locate the drawing file to upload. The file can be uploaded when the file has been selected with the user pressing a next button, for example with a pointer on a display.

FIG. 5D2 shows a second user interface screen configuration 620 to receive input of the user so as to initiate a second step. The screen shows user inputs that can be selected based on the file transmitted from the factory server to the user processor based on the file uploaded and the programs of the factory server as described above.

The user can select a geometry layer, for example Rubber, and the selected layer may correspond to a layer of the file transmitted to the factory server and based on the file returned from the factory server. The geometry layer can be one a plurality of selections available to the user based on the layers of the drawing file transmitted to the factory server. The layer can comprise a label used with the DXF file to further tag objects, such as lines and circles with additional information. The processor system may be configured to require the geometry layer to contain all edges of the gasket, internal, external and holes and to be labeled with a unique layer name. This identification can be performed by the user with menu selection in response to the file information transmitted from the factory server to the user processor.

The user can select a material, for example based on a location of the user and material present at the cutting machine location corresponding to the location of the user. The plurality of sheet materials that can be selected by the user can include one or more of the following examples: silicone rubber, 1/32″ thick, orange, medical grade; industrial rubber, 1/16″ thick, orange industrial grade; neoprene rubber, black 3 mm thick, high durometer; polyethylene foam, adhesive backed 1/16″ thick; poron foam rubber ⅛″ thick, closed cell, no texture; or cork sheeting, 1/16″ thick.

The user can select a condition for internal edges of the cut part, for example internal holes to be formed in a cut gasket. The condition may comprise one of best fit, minimum material, or maximum material. The user can control the material condition separately for external and internal edges, so as to ensure the best combination of form, fit and function. For example, the inside of a gasket can be exposed to a different environment than the outside and the user can select the fit for the use of the part.

The user can select a condition for external edges of the cut part, for example external edges to be formed in a cut gasket. The condition may comprise one of best fit, minimum material, or maximum material. The user can control the material condition separately for external and internal edges, so as to ensure the best combination of form, fit and function. There can be one continuous external edge of the part such as a gasket and the part can be represented as a two dimensional object, in which the customer adds the thickness separately from the drawing, for example with the selection as described above. The customer may have three choices for the cutting of the non straight edges of the gasket such as arcs, circles, ellipses, etc. The choices may comprise: maximum material condition, minimum material condition, or best fit. The fit can be shown by illustration of what each choice means based on the image of the part shown to the user based on the selection.

The user can select a condition for internal edges of the cut part, for example internal holes to be formed in a cut gasket. The condition may comprise one of best fit, minimum material, or maximum material. The user can control the material condition separately for external and internal edges, so as to ensure the best combination of form, fit and function. For example, the inside of a gasket can be exposed to a different environment than the outside and the user can select the fit for the use of the part.

The user interface screen shows an image of the part based on the file sent from the factory server.

FIG. 5D2A shows the Maximum Material Condition for External and Internal Edges. The dashed line represents the gasket as drawn and the solid line represents the gasket as it will be cut. Maximum Material Condition means there will always be excess material after the cutting process. The user selects this setting when the user wants to be sure there is enough gasket material for the seal and when the excess material will not interfere with appearance and mating parts. The amount of excess material is controlled by the Tolerance parameter.

FIG. 5D2B shows Minimum Material Condition for External and Internal Edges. The dashed line represents the gasket as drawn and the solid line represents the gasket as it will be cut. Minimum Material Condition means there will never be excess material after the cutting process. The user can select this setting when the user wants to be sure there is enough gasket material for the seal and when you do not want excess material to interfere with appearance and mating parts. The amount of subtracted material is controlled by the Tolerance parameter.

FIG. 5D2C shows the Best-Fit Condition for External and Internal Edges. The dashed line represents the gasket as drawn and the solid line represents the gasket as it will be cut. Best-Fit Condition means the amount of excess material is equal to the amount of subtracted material after the cutting process. The user can select this setting when sure there is enough gasket material for the seal and when the user wants to average excess and subtracted material. The amount of excess/subtracted material is controlled by the Tolerance parameter.

The user processor and display can be configured with pop up screens for each of the plurality of menu selections. For example each “i” shown may correspond to a pop up window for the user to obtain information with regards to the selection of each condition described above, for example with reference to FIGS. 5D2A to 5D2C, for example.

The user interface screen may comprise an image 624 comprising the profile of the uploaded to the factory server.

The user can select the quote button to obtain additional information with regards to the manufacturing of the part from the sheet material.

FIG. 5D3 shows a configuration 630 of the user interface screen so as to receive input of a third user step and order the manufacture of the part based on the selections and such that the part is manufactured based on the selections. The input screen comprises an input button 632 for the user to select the order and initiate manufacture of the part in response to the commands and selections from the user. The screen can show an enlarged image 634 on the display. The user can select from among a plurality 640 of images. The plurality of images may comprise: a part image 642 comprising a profile of the part based on the uploaded drawing file such as the dxf file; a cut image 644 comprising a cut profile of the part corresponding to the cut part manufactured with the plurality of cuts of the blade; and an overlay image 646 comprising the profile of the part overlaid on the cut profile of the part. This display of the part profile with the cut profile allows the user to ensure that the part is suitable for the user before the part instructions to manufacture the part are transmitted by the user with the ordered.

FIG. 5E shows a user input gasket image 642 comprising the part profile of the user interface screen.

FIG. 5F shows a target cut gasket image 644 comprising the cut profile of the user interface screen, in accordance with embodiments;

FIG. 5G shows the image 646 comprising the user input gasket image overlaid on the target cut gasket image; and

While the exemplary embodiments have been described in some detail, by way of example and for clarity of understanding, those of skill in the art will recognize that a variety of modifications, adaptations, and changes may be employed. Hence, the scope of the present invention should be limited solely by the appended claims.

What is claimed is:

1. An apparatus to cut material, the apparatus comprising:
an elongate cutting blade extending a distance to cut a sheet of material with an elongate cut; and
a linkage comprising a shaft component and a second component, the shaft component coupled to the cutting blade to move the cutting blade in a first direction to cut the sheet of material, the shaft component coupled to the blade to rotate the elongate blade about an axis of rotation to an angle to cut the sheet of material, the axis of rotation extending along the first direction, the second component movable along a second direction to couple to the shaft component to maintain the angle of elongate cutting blade when the sheet is cut with the elongate cutting blade rotated to the angle; and
a joint to adjust a second angle of the blade, the joint disposed between the blade and the shaft to couple the shaft to the blade, the joint comprising a convexly curved bearing surface and a concavely curved bearing surface, wherein the convexly curved bearing surface comprises a radius of curvature, the radius of curvature sized to extend from the convexly curved surface to the blade, such that the blade pivots when the convex surface slides along the concave surface.

2. (canceled)

3. The apparatus of claim 1, wherein the shaft component is coupled to a spring to urge the blade into the material with force of the spring when the spring is compressed.

4. (canceled)

5. The apparatus of claim 1, wherein the joint is affixed to a retention structure to maintain a the second angle of the blade when the material is cut.

6.-18. (canceled)

19. An apparatus, the apparatus comprising:
a processor system comprising at least one processor having at least one tangible medium with instructions of a computer program embodied thereon, the at least one tangible medium comprising instructions to receive input data of a part having a part profile from a user and instructions to determine a cut profile, the cut profile corresponding to a plurality of straight cuts positioned and oriented to correspond to the part profile, the at least one tangible medium comprising instructions to generate an image comprising the part profile positioned with the cut profile for the user to compare the part profile with the cut profile.

20. The apparatus of claim 19 wherein the cuts comprise substantially straight cuts.

21. The apparatus of claim 19 wherein the cuts comprise curved cuts.

22. The apparatus of claim 19 wherein the processor system is configured to select an elongate substantially straight first blade for a first series of elongate substantially straight cuts and a second curved blade for a second at least one cut.

23. The apparatus of claim 19 wherein the processor system comprises a user processor at a user location, a factory server at a server location remote from the user, and a machine processor located at a machine location.

24. The apparatus of claim 23 wherein the wherein the user processor comprises a user interface with a display and an input of the user to upload the input data comprising the part profile to the factory server.

25. The apparatus of claim 24 wherein the user interface comprises a plurality of menus to select one or more of type of material, a thickness of material, a fit of the cut profile to the part profile or a length of the substantially cuts.

26. The apparatus of claim 24 wherein the user interface comprises an input to generate a price quote for the cut part when the image of the cut profile is shown with the part profile on the display.

27. The apparatus of claim 23 wherein the user processor comprises instructions to display the image and accept an input of the user to manufacture the part with the cut profile.

28. The apparatus of claim 23 wherein the factory server comprises instructions to generate the image based on the part profile and transmit the image to the user processor.

29.-35. (canceled)

36. The apparatus of claim 23 wherein machine processor comprises instructions to cut the part with the cut profile in response to the input of the user to manufacture the part.

37. The apparatus of claim 36 wherein the instructions to cut the part comprise a user input of one or more of material condition for an internal edge, material condition for an external edge or a tolerance of the cut.

38. The apparatus of claim 36 wherein the instructions to cut the part comprise a plurality of positions and orientations of a plurality of cuts such that the cut profile correspond to the part profile.

39. The apparatus of claim 36 wherein an edge of the part comprises a circular edge and wherein the instructions determine to cut the circular edge with one or more of a circular punch, a curved blade or a substantially straight blade based on a tolerance input from the user and available cutting tools loaded of the machine when the user submits the input.

40. The apparatus of claim 39 wherein the instructions are configured to select the one of the circular punch or the substantially straight blade based on the tolerance selected by the user and the available cutting tools loaded on the machine when the user submits the input.

41.-44. (canceled)

45. A method, the method comprising:
displaying an image of a cut part to a user located remote from a machine to cut the part, wherein the image comprises first profile of the part overlaid on second cut profile of the part.

46.-47. (canceled)

48. The method of claim 45 further comprising:
providing a means for a user located remote from a machine to cut a part, wherein the means provides instructions for the machine to cut the part to the user's specification without the user having knowledge of the machine's cutting processes or construction;
wherein a machine processes is used to generate an image of the part to be cut such that the user can understand and view the part to be cut remote from the cutting machine without substantial knowledge of the cutting processes or construction of the cutting machine.

49. (canceled)
